(19) United States
(12) Patent Application Publication
(10) Pub. No.: US 2023/0154667 A1
(43) Pub. Date: May 18, 2023

(54) INDUCTOR DEVICE

(71) Applicant: Realtek Semiconductor Corporation, Hsinchu (TW)

(72) Inventor: Hsiao-Tsung YEN, Hsinchu (TW)

(21) Appl. No.: 17/663,214

(22) Filed: May 13, 2022

(30) Foreign Application Priority Data
Nov. 16, 2021 (TW) 110142599

(51) Int. Cl. H01F 27/29; H01F 17/00; H01F 27/28

(52) U.S. Cl. CPC H01F 27/29; H01F 17/0006; H01F 27/2804; H01F 2017/0073

(57) ABSTRACT

An inductor device includes a plurality of coils including a first winding and a second winding. The first winding includes a plurality of first sub-coils, wherein a first one of the plurality of first sub-coils is configured in a first region, and a second one and a third one of the plurality of first sub-coils are configured in a second region different from the first region. The second winding includes a plurality of second sub-coils, wherein a first one of the plurality of second sub-coils is configured in the second region, and a second one and a third one of the plurality of second sub-coils are configured in the first region. Each of the plurality of coils is composed of one of the plurality of first sub-coils and one of the plurality of second sub-coils.

### CROSS-REFERENCE TO RELATED APPLICATION

This application claims priority to Taiwan Application Serial Number 110142599, filed Nov. 16, 2021, which is herein incorporated by reference in its entirety.

### BACKGROUND

### Field of Invention

This disclosure relates to an electronic device, and in particular to an inductor device.

### Description of Related Art

Various types of existing inductors have their own advantages and disadvantages. For an inductor having a structure of interleaved coils, its parasitic capacitance is low, which results in a low self-resonance frequency and a low quality factor. Therefore, the application range of the aforementioned inductor is limited.

### SUMMARY

An aspect of present disclosure relates to an inductor device. The inductor device includes a plurality of coils including a first winding and a second winding. The first winding includes a plurality of first sub-coils, wherein a first one of the plurality of first sub-coils is configured in a first region, and a second one and a third one of the plurality of first sub-coils are configured in a second region different from the first region. The second winding includes a plurality of second sub-coils, wherein a first one of the plurality of second sub-coils is configured in the second region, and a second one and a third one of the plurality of second sub-coils are configured in the first region. Each of the plurality of coils is composed of one of the plurality of first sub-coils and one of the plurality of second sub-coils.

### BRIEF DESCRIPTION OF THE DRAWINGS

FIG. 1 is a schematic diagram of an inductor device in accordance with some embodiments of the present disclosure;

FIG. 2 is a schematic diagram of an inductor device in accordance with some embodiments of the present disclosure;

FIG. 3 is a schematic diagram of an inductor device in accordance with some embodiments of the present disclosure;

FIG. 4 is a schematic diagram of an inductor device in accordance with some embodiments of the present disclosure;

FIG. 5 is a schematic diagram of an inductor device in accordance with some embodiments of the present disclosure; and

FIG. 6 is a schematic diagram of experimental data of the inductor device in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

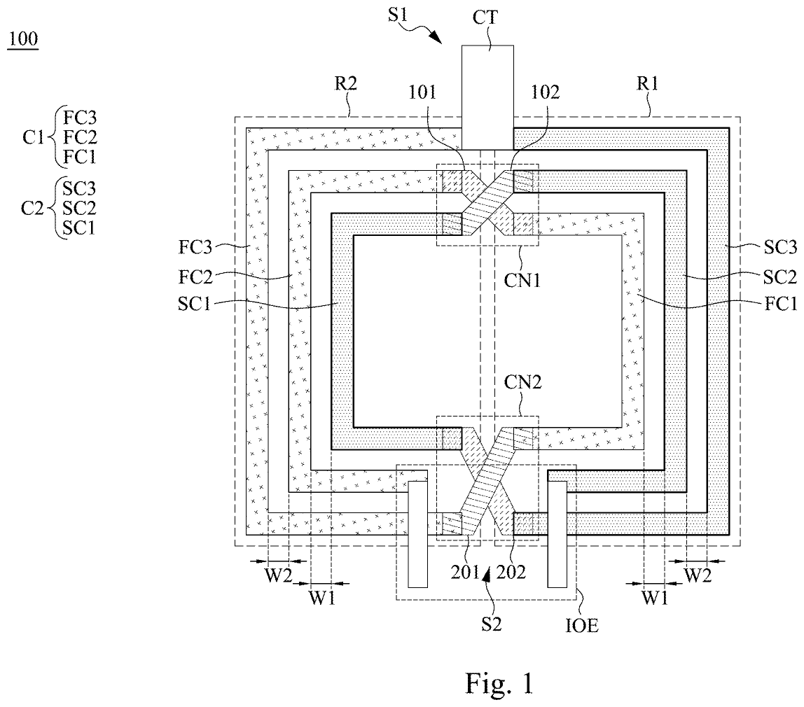

Referring to FIG. 1, FIG. 1 a schematic diagram of an inductor device 100 in accordance with some embodiments of the present disclosure. The inductor device 100 includes a plurality of coils, a first crossing portion CN1, a second crossing portion CN2, a central tap terminal CT and an input-output terminal 10E. In particular, the coils of the inductor device 100 are composed of a first winding C1 (presented by areas filled with cross lines) and a second winding C2 (presented by areas filled with dots).

In some embodiments, as shown in FIG. 1, the first winding C1 includes a plurality of first sub-coils FC1-FC3. The first sub-coil FC1 (i.e., a first one of the first sub-coils) is configured in a first region R1, and other first sub-coils FC2-FC3 (i.e., a second one and a third one of the first sub-coils) are configured in a second region R2 different from the first region R1. For example, the first region R1 is a right region of FIG. 1, and the second region R2 is a left region of FIG. 1.

The second winding C2 also includes a plurality of second sub-coils SC1-SC3. The second sub-coil SC1 (i.e., a first one of the second sub-coils) is configured in the second region R2 together with the first sub-coils FC2-FC3, and other second sub-coils SC2-SC3 (i.e., a second one and a third one of the second sub-coils) are configured in the first region R1 together with the first sub-coil FC1.

In some embodiments, as shown in FIG. 1, each of the coils of the inductor device 100 is composed of one of the first sub-coils FC1-FC3 and one of the second sub-coils SC1-SC3. For example, the inductor device 100 is configured with a first coil, a second coil and a third coil from inside to outside. The first coil of the inductor device 100 is composed of the first sub-coil FC1 and the second sub-coil SC1, the second coil of the inductor device 100 is composed of the first sub-coil FC2 and the second sub-coil SC2, and the third coil of the inductor device 100 is composed of the first sub-coil FC3 and the second sub-coil SC3.

In some embodiments, the first crossing portion CN1 includes a plurality of connecting members 101 and 102. As shown in FIG. 1, the connecting member 101 is configured to couple the first sub-coil FC1 and the first sub-coil FC2, and the connecting member 102 is configured to couple the second sub-coil SC1 and the second sub-coil SC2. It can be appreciated that the connecting members 101 and 102 are intersected with each other and in different metal layers. For example, the connecting member 101 is located in a first metal layer, and the connecting member 102 is located in a second metal layer.

In some embodiments, the second crossing portion CN2 includes a plurality of connecting members 201 and 202. As shown in FIG. 1, the connecting member 201 is configured to couple the first sub-coil FC1 and the first sub-coil FC3, and the connecting member 202 is configured to couple the second sub-coil SC1 and the second sub-coil SC3. It can be appreciated that the connecting members 201 and 202 are intersected with each other and in different metal layers. For example, the connecting member 201 is located in the second metal layer, and the connecting member 202 is located in the first metal layer.

In some embodiments, the first crossing portion CN1 is on a first side S1 of the inductor device 100, and the second crossing portion CN2 is on a second side S2 of the inductor device 100. As shown in FIG. 1, the first side S1 (e.g., an upper side) and the second side S2 (e.g., a lower side) are two opposite sides.

In the embodiment of FIG. 1, the input-output terminal 10E is configured to input or output signal and is coupled to the first sub-coil FC2 and the second sub-coil SC2 on the second side S2 of the inductor device 100. In addition, the central tap terminal CT is coupled to the first sub-coil FC3 and the second sub-coil SC3 on the first side S1 of the inductor device 100.

In some embodiments, the first sub-coils FC1-FC3, the second sub-coils SC1-SC3 and the connecting members 101 and 202 are located in the same metal layer (i.e., the first metal layer), but the present disclosure is not limited herein. In other embodiments, the first sub-coils FC1-FC3 and the second sub-coils SC1-SC3 are located in the second metal layer.

In some embodiments, the first metal layer is different from the second metal layer. For example, the first metal layer is an ultra-thick metal (UTM) layer, and the second metal layer is aluminum redistribution layer (AL-RDL). It can be appreciated that the present disclosure is not limited herein.

The structure of the first winding C1 is described first. In detail, the first sub-coil FC2 is coupled to the input-output terminal 10E on the second side S2, is wound clockwise from the second side S2 to the first side S1, and is directly coupled to a terminal of the connecting member 101 on the first side S1. Another terminal of the connecting member 101 is directly coupled to the first sub-coil FC1. The first sub-coil FC1 is wound clockwise from the first side S1 to the second side S2, and is coupled to a terminal of the connecting member 201 through a via on the second side S2. Another terminal of the connecting member 201 is coupled to the first sub-coil FC3 through a via. The first sub-coil FC3 is wound clockwise from the second side S2 to the first side S1, and is coupled to the central tap terminal CT directly or indirectly (for example, through a via) on the first side S1.

The structure of the second winding C2 is described then. In detail, the second sub-coil SC2 is coupled to the input-output terminal 10E on the second side S2, is wound counterclockwise from the second side S2 to the first side S1, and is coupled to a terminal of the connecting member 102 through a via on the first side S1. Another terminal of the connecting member 102 is coupled to the second sub-coil SC1 through a via. The second sub-coil SC1 is wound counterclockwise from the first side S1 to the second side S2, and is directly coupled to a terminal of the connecting member 202 on the second side S2. Another terminal of the connecting member 202 is directly coupled to the second sub-coil SC3. The second sub-coil SC3 is wound counterclockwise from the second side S2 to the first side S1, and is coupled to the central tap terminal CT directly or indirectly (for example, through a via) on the first side S1.

In the embodiment of FIG. 1, the first sub-coil FC1 of the first winding C1 and the second sub-coils SC2-SC3 of the second winding C2 are distributed in different positions of the first region R1 (in other words, the first sub-coil FC1 of the first winding C1 and the second sub-coils SC2-SC3 of the second winding C2 are not overlapped with each other). The first sub-coils FC2-FC3 of the first winding C1 and the second sub-coil SC1 of the second winding C2 are distributed in different positions of the second region R2 (in other words, the first sub-coils FC2-FC3 of the first winding C1 and the second sub-coil SC1 of the second winding C2 are not overlapped with each other).

In particular, in the second region R2 of FIG. 1, the second sub-coil SC1 and the first sub-coil FC2 are spaced at a first interval W1, the first sub-coil FC2 and the first sub-coil FC3 are spaced at a second interval W2, and the first interval W1 is equal to the second interval W2. Similarly, in the first region R1 of FIG. 1, the first sub-coil FC1 and the second sub-coil SC2 are spaced at the first interval W1, the second sub-coil SC2 and the second sub-coil SC3 are spaced at the second interval W2.

It can be appreciated that the first sub-coils FC1-FC3 are configured to transmit first signals with same polarity (e.g., same positive polarity signals or same negative polarity signals), the second sub-coils SC1-SC3 are configured to transmit second signals with same polarity (e.g., same negative polarity signals or same positive polarity signals), and the first signals are different from the second signals. Notably, by the configuration of the first crossing portion CN1 and the second crossing portion CN2, most of the first sub-coils (e.g., the first sub-coil FC2 and the first sub-coil FC3) are configured in the second region R2 and are adjacent to each other, and most of the second sub-coils (e.g., the second sub-coil SC2 and the second sub-coil SC3) are configured in the first region R1 and are adjacent to each other. Accordingly, since the coils in same region are responsible for transmitting signals with same polarity, the equivalent parasitic capacitance value of the inductor device 100 can be reduced dramatically, and the equivalent inductance vale and the quality factor of the inductor device 100 can be increased dramatically.

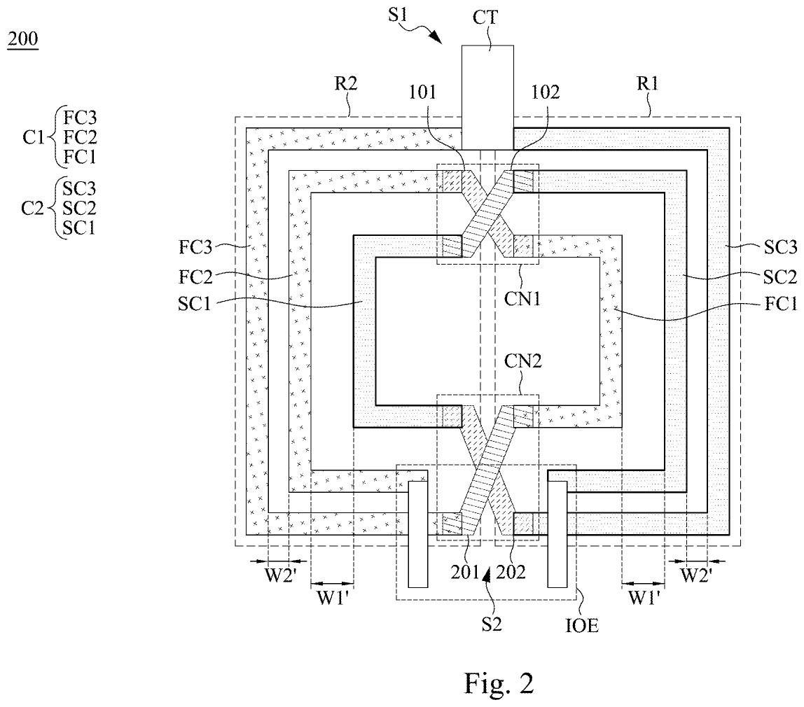

Referring to FIG. 2, FIG. 2 a schematic diagram of an inductor device 200 in accordance with some embodiments of the present disclosure. The symbols in FIG. 2 which are same as those in FIG. 1 represent same or similar component, and therefore the description thereof is omitted herein. In the second region R2 of FIG. 2, the second sub-coil SC1 and the first sub-coil FC2 are spaced at a first interval W1′, the first sub-coil FC2 and the first sub-coil FC3 are spaced at a second interval W2′, and the first interval W1′ is at least about 1.5 times the second interval W2. Similarly, in the first region R1 of FIG. 2, the first sub-coil FC1 and the second sub-coil SC2 are spaced at the first interval W1′, the second sub-coil SC2 and the second sub-coil SC3 are spaced at the second interval W2′.

In the embodiment of FIG. 2, since the first interval W1′ between the first sub-coil FC1 and the second sub-coil SC2 (or between the second sub-coil SC1 and the first sub-coil FC2) is increased, the inductor device 200 of FIG. 2 has an equivalent parasitic capacitance value lower than those of the inductor device 100 of FIG. 1.

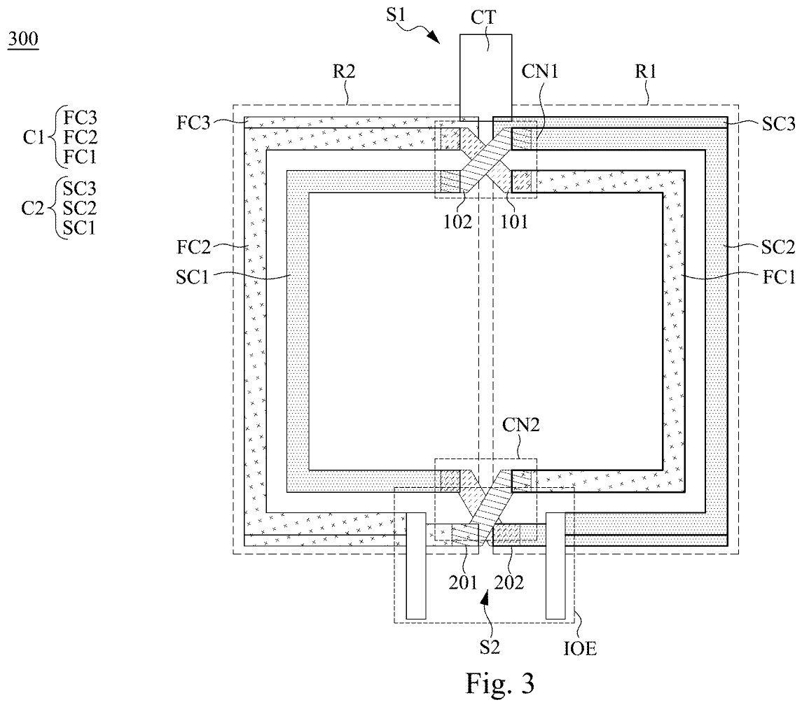

In the embodiments of FIGS. 1 and 2, the coils of the inductor devices 100 and 200 are located in the same layer, but the present disclosure is not limited herein. In other embodiments, some coils of the inductor device are overlapped with each other. The descriptions would be made below by taking the embodiment of FIG. 3 as an example.

Referring to FIG. 3, FIG. 3 a schematic diagram of an inductor device 300 in accordance with some embodiments of the present disclosure. The symbols in FIG. 3 which are same as those in FIG. 1 represent same or similar component, and therefore the description thereof is omitted herein. In the second region R2 of FIG. 3, the first sub-coil FC2 and the first sub-coil FC3 are located in different metal layers and are overlapped with each other, and the second sub-coil SC1 and the first sub-coil FC3 are located at the same metal layer and are not overlapped with each other. Similarly, in the first region R1 of FIG. 3, the second sub-coil SC2 and the second sub-coil SC3 are located in different metal layers and are overlapped with each other, and the first sub-coil FC1 and the second sub-coil SC3 are located at the same metal layer and are not overlapped with each other. In other words, the second coil of the inductor device 300 (i.e., the first sub-coil FC2 and the second sub-coil SC2) and the third coil of the inductor device 300 (i.e., the first sub-coil FC3 and the second sub-coil SC3) are overlapped with each other, and are not overlapped with the first coil of the inductor device 300 (i.e., the second sub-coil SC1 and the first sub-coil FC1).

In the embodiment of FIG. 3, since the second coil and the third coil of the inductor device 300 are overlapped with each other, the inductor device 300 of FIG. 3 has an equivalent inductance value and a quality factor higher than those of the inductor device 100 of FIG. 1.

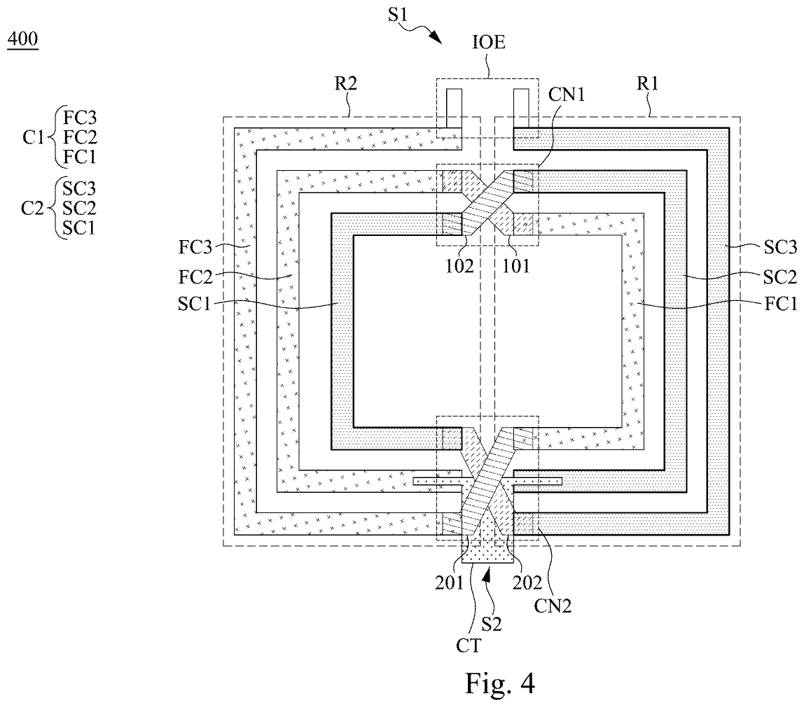

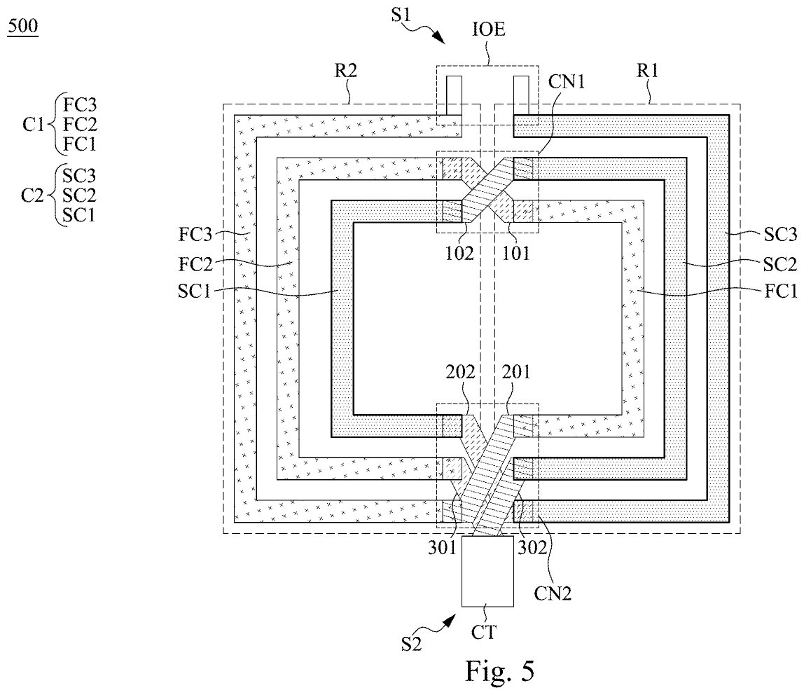

In the embodiments of FIGS. 1, 2 and 3, the central tap terminal CT is located on the first side S1 of the inductor device, and the input-output terminal IOE is located on the second sides S2 of the inductor device. However, the present disclosure is not limited herein. The position of the central tap terminal CT and the input-output terminal IOE can be change according to the requirement. The descriptions would be made below by taking the embodiments of FIGS. 4 and 5 as examples.

Referring to FIG. 4, FIG. 4 a schematic diagram of an inductor device 400 in accordance with some embodiments of the present disclosure. The symbols in FIG. 4 which are same as those in FIG. 1 represent same or similar component, and therefore the description thereof is omitted herein. In the embodiment of FIG. 4, the central tap terminal CT is located on the second side S2 of the inductor device 400, and the input-output terminal IOE is located on the first sides S1 of the inductor device 400. In particular, the central tap terminal CT can be coupled to the first sub-coil FC2 and the second sub-coil SC2 through vias on the second side S2, and is located in a different metal layer from at least the connecting members 201 and 202, the second coil of the inductor device 400 (i.e., the first sub-coil FC2 and the second sub-coil SC2) and the third coil of the inductor device 400 (i.e., the first sub-coil FC3 and the second sub-coil SC3). In addition, the input-output terminal IOE is coupled to the first sub-coil FC3 and the second sub-coil SC3 directly or indirectly on the first sides S1.

Referring to FIG. 5, FIG. 5 a schematic diagram of an inductor device 500 in accordance with some embodiments of the present disclosure. The symbols in FIG. 5 which are same as those in FIG. 1 represent same or similar component, and therefore the description thereof is omitted herein. In the embodiment of FIG. 5, the central tap terminal CT is located on the second side S2 of the inductor device 500, and the input-output terminal IOE is located on the first sides S1 of the inductor device 500. In particular, the central tap terminal CT can be coupled to the first sub-coil FC2 through a connecting member 301 on the second side S2, and can be coupled to the second sub-coil SC2 through another connecting member 302 on the second side S2. The connecting members 301 and 302 are located in different metal layers. For example, the connecting member 301 is located in the first metal layer as the connecting member 202, and the connecting member 302 is located in the second metal layer as the connecting member 201. It can be appreciated that the connecting member 301 is intersected with the connecting member 201, and that the connecting member 302 is intersected with the connecting member 202. In addition, the input-output terminal 10E is coupled to the first sub-coil FC3 and the second sub-coil SC3 directly or indirectly on the first sides S1.

In the above embodiments, the inductor device (e.g., the inductor device 100 of FIG. 1, the inductor device 200 of FIG. 2, the inductor device 300 of FIG. 3, the inductor device 400 of FIG. 4, the inductor device 500 of FIG. 5) has a square structure (i.e., a quadrilateral structure). It can be appreciated that the inductor device can also be other polygonal structure in other embodiments. In addition, the structure of the inductor device of the above embodiments can also be applied to a figure-eight inductor device.

It can be appreciated that the number of the coils of the first winding C1 and the number of the coils of the second winding C2 are only for illustrated purpose, and the present disclosure is not limited to the number as shown in the drawings. In other words, the number of the coils of the inductor device is not limited to 3 as shown in the drawings.

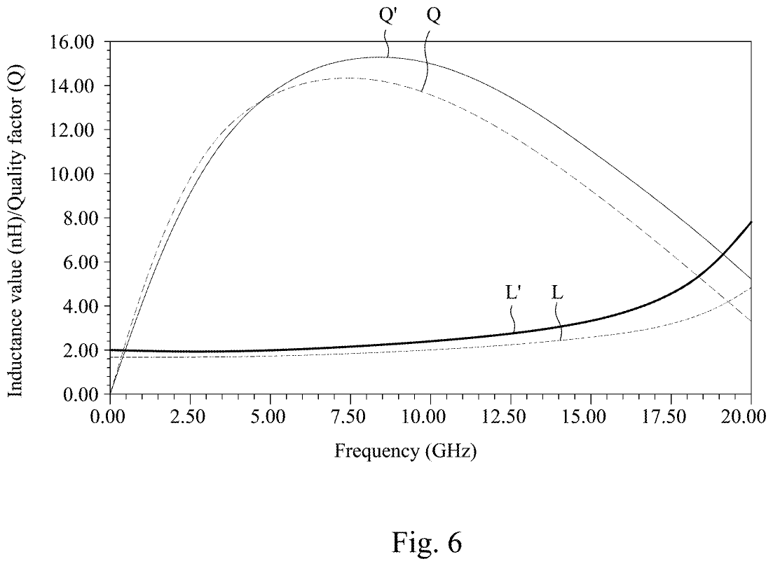

Referring to FIG. 6, FIG. 6 is a schematic diagram of experimental data of the inductor device in accordance with some embodiments of the present disclosure and experimental data of the prior art. As shown in FIG. 6, by adopting the structural configuration of the present disclosure, the experimental curve of the quality factor of the inductor device is Q′ (presented by solid line), and the experimental curve of the inductance value of the inductor device is L′ (presented by solid line). By adopting the prior art, the experimental curve of the quality factor of the inductor device is Q (presented by broken line), and the experimental curve of the inductance value of the inductor device is L (presented by broken line). It can be seen from FIG. 6 that the inductor device adopting the structure of the present disclosure has better quality factor and inductance value in comparison to the prior art. For example, the inductance value of the inductor device of the present disclosure is increased by about 15% at the frequency of 4.8 GHz in comparison to the prior art.

It can be seen from the above embodiments of the present disclosure that the inductor device of the present disclosure (e.g., the inductor device 100 of FIG. 1, the inductor device 200 of FIG. 2, the inductor device 300 of FIG. 3, the inductor device 400 of FIG. 4, the inductor device 500 of FIG. 5) has the advantage of reduced equivalent parasitic capacitance value by arranging multiple coils for transmitting same polarity signals and few coils for transmitting different polarity signals in same region. In addition, the inductor device can further increase the inductance value and the quality factor by the structure of the present disclosure.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. An inductor device, comprising:
a plurality of coils comprising:
a first winding comprising a plurality of first sub-coils, wherein a first one of the plurality of first sub-coils is configured in a first region, and a second one and a third one of the plurality of first sub-coils are configured in a second region different from the first region; and
a second winding comprising a plurality of second sub-coils, wherein a first one of the plurality of second sub-coils is configured in the second region, and a second one and a third one of the plurality of second sub-coils are configured in the first region;
wherein each of the plurality of coils is composed of one of the plurality of first sub-coils and one of the plurality of second sub-coils.

2. The inductor device of claim 1, wherein the first one of the plurality of second sub-coils, the second one of the plurality of first sub-coils and the third one of the plurality of first sub-coils are located in a same metal layer and are not overlapped with each other;
wherein the first one of the plurality of first sub-coils, the second one of the plurality of second sub-coils and the third one of the plurality of second sub-coils are located in a same metal layer and are not overlapped with each other.

3. The inductor device of claim 2, wherein the first one of the plurality of second sub-coils and the second one of the plurality of first sub-coils are spaced at a first interval, and the second one of the plurality of first sub-coils and the third one of the plurality of first sub-coils are spaced at a second interval, wherein the first interval is equal to the second interval.

4. The inductor device of claim 3, wherein the first one of the plurality of first sub-coils and the second one of the plurality of second sub-coils are spaced at the first interval, and the second one of the plurality of second sub-coils and the third one of the plurality of second sub-coils are spaced at the second interval.

5. The inductor device of claim 2, wherein the first one of the plurality of second sub-coils and the second one of the plurality of first sub-coils are spaced at a first interval, and the second one of the plurality of first sub-coils and the third one of the plurality of first sub-coils are spaced at a second interval, wherein the first interval is at least 1.5 times the second interval.

6. The inductor device of claim 5, wherein the first one of the plurality of first sub-coils and the second one of the plurality of second sub-coils are spaced at the first interval, and the second one of the plurality of second sub-coils and the third one of the plurality of second sub-coils are spaced at the second interval.

7. The inductor device of claim 1, wherein the second one of the plurality of first sub-coils and the third one of the plurality of first sub-coils are located in different metal layers and are overlapped with each other.

8. The inductor device of claim 7, wherein the first one of the plurality of second sub-coils and the third one of the plurality of first sub-coils are located in a same metal layer and are not overlapped with each other.

9. The inductor device of claim 8, wherein the second one of the plurality of second sub-coils and the third one of the plurality of second sub-coils are located in different metal layers and are overlapped with each other.

10. The inductor device of claim 9, wherein the first one of the plurality of first sub-coils and the third one of the plurality of second sub-coils are located in a same metal layer and are not overlapped with each other.

11. The inductor device of claim 1, wherein the inductor device further comprises a first crossing portion, and the first crossing portion is configured to couple the first one of the plurality of first sub-coils and the second one of the plurality of first sub-coils, and is configured to couple the first one of the plurality of second sub-coils and the second one of the plurality of second sub-coils.

12. The inductor device of claim 11, wherein the first crossing portion comprises a first connecting member and a second connecting member, the first connecting member is configured to couple the first one of the plurality of first sub-coils and the second one of the plurality of first sub-coils, the second connecting member is configured to couple the first one of the plurality of second sub-coils and the second one of the plurality of second sub-coils, and the first connecting member and the second connecting member are intersected with each other.

13. The inductor device of claim 11, wherein the inductor device further comprises a second crossing portion, and the second crossing portion is configured to couple the first one of the plurality of first sub-coils and the third one of the plurality of first sub-coils, and is configured to couple the first one of the plurality of second sub-coils and the third one of the plurality of second sub-coils.

14. The inductor device of claim 13, wherein the second crossing portion comprises a first connecting member and a second connecting member, the first connecting member is configured to couple the first one of the plurality of first sub-coils and the third one of the plurality of first sub-coils, the second connecting member is configured to couple the first one of the plurality of second sub-coils and the third one of the plurality of second sub-coils, and the first connecting member and the second connecting member are intersected with each other.

15. The inductor device of claim 13, wherein the first crossing portion is located on a first side of the inductor device, and the second crossing portion is located on a second side of the inductor device, wherein the first side and the second side are two opposite sides.

16. The inductor device of claim 15, wherein the inductor device further comprises an input-output terminal, and the input-output terminal is located on the second side of the inductor device and is coupled to the second one of the plurality of first sub-coils and the second one of the plurality of second sub-coils.

17. The inductor device of claim 16, wherein the inductor device further comprises a central tap terminal, and the central tap terminal is located on the first side of the inductor device and is coupled to the third one of the plurality of first sub-coils and the third one of the plurality of second sub-coils.

18. The inductor device of claim 15, wherein the inductor device further comprises an input-output terminal, and the input-output terminal is located on the first side of the inductor device and is coupled to the third one of the plurality of first sub-coils and the third one of the plurality of second sub-coils.

19. The inductor device of claim 18, wherein the inductor device further comprises a central tap terminal, and the central tap terminal is located on the second side of the inductor device and is coupled to the second one of the plurality of first sub-coils and the second one of the plurality of second sub-coils.

20. The inductor device of claim 19, wherein the inductor device further comprises a first connecting member and a second connecting member, the first connecting member is configured to couple the second one of the plurality of first sub-coils and the central tap terminal, the second connecting member is configured to couple the second one of the plurality of second sub-coils and the central tap terminal, and the first connecting member and the second connecting member are both intersected with the second crossing portion.
